(19) United States
(12) Patent Application Publication
(10) Pub. No.: US 2015/0012975 A1
(43) Pub. Date: Jan. 8, 2015

(54) Method for Assigning Users to Transactions in a Multitenant Service Platform

(71) Applicant: Timo HOTTI, Lohja (FI)

(72) Inventor: Timo HOTTI, Lohja (FI)

(21) Appl. No.: 14/316,364

(22) Filed: Jun. 26, 2014

(30) Foreign Application Priority Data
Jul. 4, 2013 (FI) 20130197

(51) Int. Cl. G06F 21/31; H04L 29/06

(52) U.S. Cl. CPC G06F 21/31; H04L 63/0428
USPC 726/4

(57) ABSTRACT

The invention discloses, inter alia, a computer-implemented method of an application service execution platform for a first user authorized to represent a first organization in the context of at least one service and a second user authorized to represent a second organization in the context of the at least one service to enter an agreement to share at least one data object owned by the first organization. The method is characterized in that it comprises steps for establishing, between the first and the second organizations represented by the first user and the second user, a data sharing agreement for the context of the at least one service, specifying in the data sharing agreement at least one data selection rule to specify data objects that are made available to the second organization for providing the service of the specified context wherein the data selection rule is at least in part defined by the context of the at least one service, and specifying in the data sharing agreement for the data objects meeting the at least one data selection rule at least one addressable destination in which the data object is available for at least one user representing the second organization or for at least one service provided by the second organization.

### BACKGROUND

This invention is related to business application services of a multitenant service execution platform. The business application services may be any computer implementable application services, including but not being limited to electronic commerce systems, e.g. electronic invoicing, purchase ordering and contract lifecycle management. The multitenant platform may be dealing with business transactions, e.g. invoices and purchase orders, where each transaction has a plurality of stakeholding parties, e.g. a sender, a receiver and a service provider and each of the stakeholding parties may be associated with a plurality of users who may need to be associated with the transactions in various contexts.

A typical method of associating users with transactions in context of a service in a multitenant service execution platform is to provide separate, possibly service specific administrative functions for the purpose. The suitable persons are then determined and access rights are granted by an administrator user using e.g. a suitable role-based access control solution. Such traditional access control methods of business application services are not practical as they require extensive amount of administrative work, e.g. in the form of frequent management of organizational structures and users' positions and roles in organizations for each service.

There thus exist various problems when combining data owned by businesses with services available for the data and assigning suitable persons as contact persons for the data and services, especially in multitenant environments that may have a large number of participating businesses such as senders, receivers and service providers.

It is an object of the present invention to provide a multitenant data management system that has capabilities e.g. for associating users with transactions in various contexts.

### BRIEF DESCRIPTION OF THE INVENTION

An aspect of the invention is a computer-implemented method of an application service execution platform for a first user authorized to represent a first organization in the context of at least one service and a second user authorized to represent a second organization in the context of the at least one service to enter an agreement to share at least one data object owned by the first organization. The method may be characterized in that it comprises steps for establishing, between the first and the second organizations represented by the first user and the second user, a data sharing agreement for the context of the at least one service, specifying in the data sharing agreement at least one data selection rule to specify data objects that are made available to the second organization for providing the service of the specified context wherein the data selection rule is at least in part defined by the context of the at least one service, and specifying in the data sharing agreement for the data objects meeting the at least one data selection rule at least one addressable destination in which the data object is available for at least one user representing the second organization or for at least one service provided by the second organization.

The context data and the data selection rules associable with the context data may be arranged to be shareable by a plurality of services and specified and maintained by services of the platform.

The association of the service with the context may be adapted to be established, maintained and/or revoked using services of the platform.

The availability of the data of the addressable destination may be arranged to be subject to the validity of the data sharing agreement. The validity of the data sharing agreement may be subject to the validity of the trust relationships of the first and the second users with their respective organizations and of the trust relationship between the first and the second users in the context of the data sharing agreement.

The method may also comprise, for the purpose of sharing service-specific information produced by the service provided by the second organization, the step of determining for the information produced by the service at least one addressable destination specified by the first organization in which destination the information is available to at least one user representing the first organization. The method may further comprise, for the purpose of sharing, with a user representing a third organization, service-specific information produced by a service provided by the second organization, the steps for creating a request to share service-specific information associable with at least one document meeting the criteria of the data sharing agreement established between the first and the second organizations, sending the request to a user representing the first organization, the user authorizing, using a service of the platform, forwarding of the request to a user representing a third organization that is also a stakeholder of the at least one document, and receiving approval from the at least one third organization wherein the data of the approval comprises address of at least one addressable destination to be used in the service-specific communication between the second and the third organization. The method may further comprise the step of updating the data sharing agreement with information about the received addressable destination to be used in the service-specific communication.

Another aspect of the present invention is a system comprising at least one server computer. The system is adapted to comprise means for performing the steps of at least one embodiment of the method disclosed herein.

Yet another aspect of the present invention is a computer program product stored in a tangible computer readable storage medium. The product is adapted to comprise computer executable instructions for the purpose of performing at least one combination of steps of at least one embodiment of the method disclosed herein.

### DRAWINGS

Some preferred embodiments of the invention are described below with references to accompanied figures, where:

FIG. 1 depicts an exemplary arrangement of software processes according to a preferred embodiment of the present invention,

FIGS. 2a-c depict relationships and management of some entities of a preferred embodiment,

FIGS. 3a-d depict some data and functional components and relationships between the components of some preferred embodiments of the present invention,

FIGS. 4a-e illustrate, using flow diagrams, some aspects of the methods of some preferred embodiments of the present invention,

FIG. 5 illustrates an example about associating services with a document and its stakeholders and users according to an embodiment of the present invention, and

FIG. 6 shows a schematic diagram of a computer usable in an embodiment of the present invention.

### DETAILED DESCRIPTION OF PREFERRED EMBODIMENTS

Various embodiments and aspects of the disclosure will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

Some portions of the detailed descriptions which follow are presented in terms of algorithms which include operations on data stored within a computer memory. An algorithm is generally a self-consistent sequence of operations leading to a desired result. The operations typically require or involve physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The present disclosure can relate to an apparatus for performing one or more of the operations described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), flash memory, magnetic or optical cards, or any type of media suitable for storing electronic instructions, and each coupled to a bus.

A machine-readable medium includes any mechanism for storing information in a form readable by a machine (e.g., a computer). For example, a machine-readable medium includes read only memory (“ROM”); random access memory (“RAM”); magnetic disk storage media; optical storage media; flash memory devices; etc.

Some embodiments of the present disclosure may include one or application programming interfaces in an environment with user interface software interacting with a software application. Various function calls or messages are transferred via the application programming interfaces between the user interface software and software applications. Transferring the function calls or messages may include issuing, initiating, invoking or receiving the function calls or messages. An API may also implement functions having parameters, variables, or pointers. An API may receive parameters as disclosed or other combinations of parameters. In addition to the APIs disclosed, other APIs individually or in combination can perform similar functionality as the disclosed APIs.

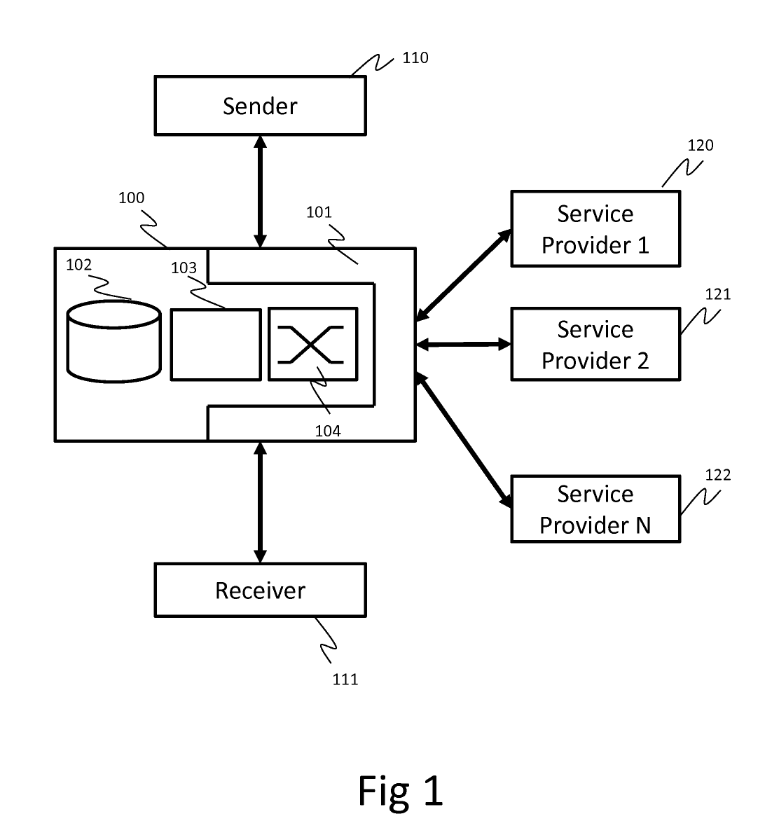

FIG. 1 depicts an arrangement of software processes according to a preferred embodiment of the present invention.

The application service execution platform 100 is a software process executable by at least one computer processor using data residing in the memory of at least one computer.

The platform 100 comprises a data communication interface 101 for the purpose of transmitting data to and from other software processes, such as process 110 sending transactions, e.g. invoices and process 111 receiving transactions. The platform is also communicatively connected via the interface 101 to software processes 120, 121, 122, that provide application services, e.g. invoice financing services or collaboration services, related to the transactions. The organizations owning data of the processes 110 and 111 represent so called primary stakeholders of a transaction and the organizations operating processes 120-122 represent so called secondary stakeholders of a transaction. The concepts of the primary and secondary stakeholders are further discussed later in this disclosure.

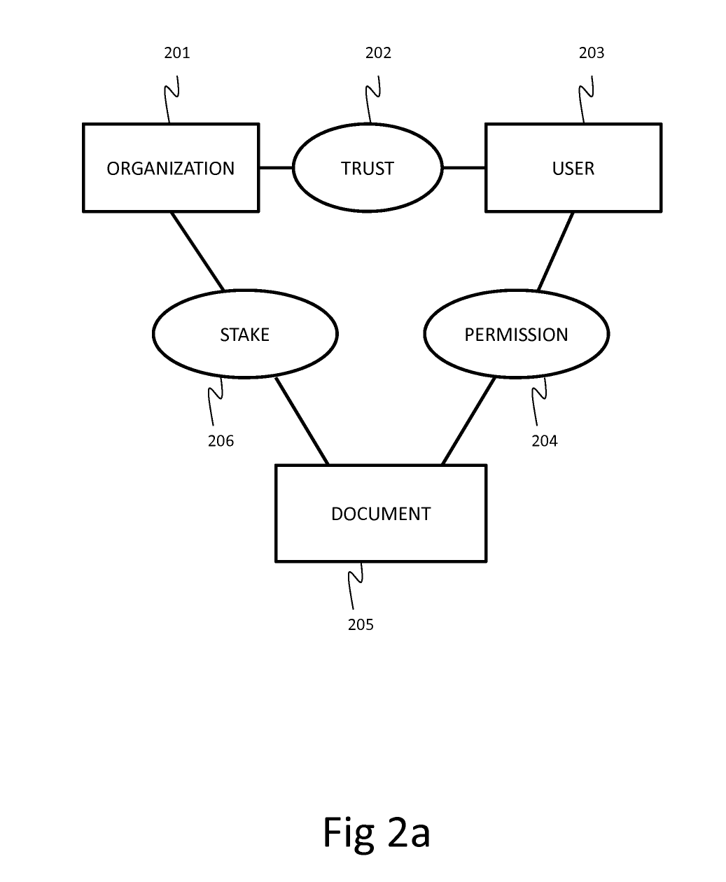

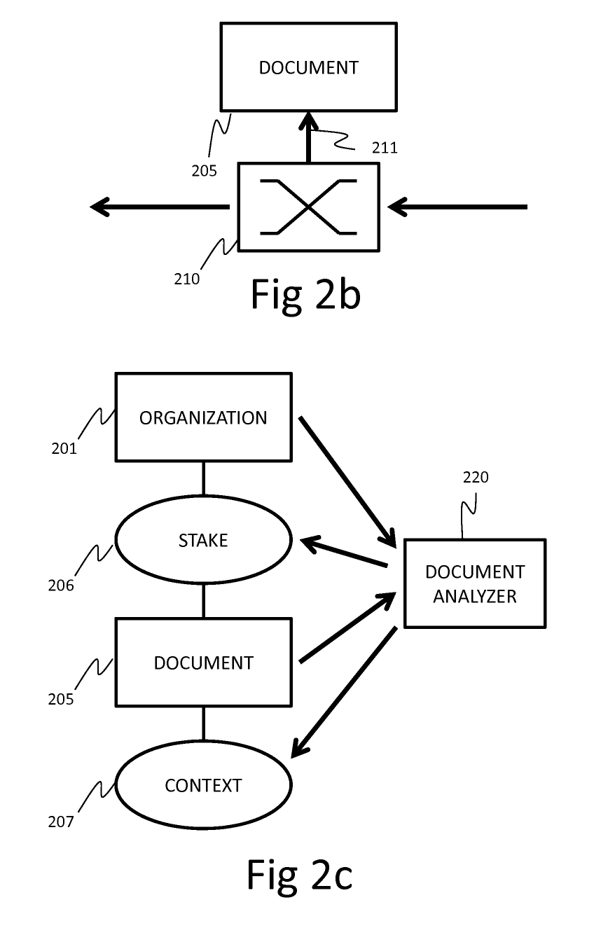

The platform 100 further comprises a data management component 102 that manages the data needed by the application logic 103 of the platform. An exemplary description of the data managed by the data management component is provided in the FIG. 2a of this detailed description. The application logic 103 is also discussed later in this detailed description. The platform further comprises a transaction routing module 104 that analyses incoming transactions and determines their destination(s). In a preferred embodiment, an incoming transaction, e.g. an invoice, is routed to its intended recipient 111 and to at least one, preferably a plurality of service providers 120, 121, 122 for the attention of at least one user at each of the recipients.

The software processes of the FIG. 1 may be arranged to be run in a single computer or they may be run in a system comprising a plurality of computers that are communicatively connected with each other using e.g. network communication interfaces. The computers may be real or virtual ones.

FIG. 2a depicts an exemplary overview of the data objects managed by the data management component (102 in FIG. 1) of the platform (100 in FIG. 1) of an embodiment of the present invention. The data comprises three main entities (data objects): organization (legal entity) data 201, user data 203 and document (transaction) data 205. Each organization may act as a stakeholder 206 of a business document 205. For example, an organization 201 may be a seller or a buyer of an invoice. An organization may be represented by at least one, preferably by a plurality of users 203 through a trust relationship 202. The trust relationship 202 may specify a context, e.g. a service class or category comprising a plurality of services, in which the user 203 may represent the organization 201. A user may delegate trust it has received from an organization further to another user thus forming a chain of trust from the user to the organization. The representation may occur e.g. via a service that is associated with the context. For example, an organization may trust a user to represent the organization in all invoicing related contexts or in a specific invoicing related context, e.g. collaboration processes between organizations that aim towards a dispute resolution. The available contexts may be defined and maintained e.g. in the access control services of the platform 100. A context may be associated, e.g. by the operator of the access control services, with any number of services and a service may be associated with multiple different contexts. For example, there may be multiple different (competing) services for the context of dispute resolution of invoices. The services may be provided by different service providers. The context may also be revoked from the service by the operator of the access control services of the platform 100.

In the embodiment shown, the user 203 is further linked to at least one document 205 via an access permission link (relationship) 204. The permission 204 may specify which kind of access the user has to the document. The access permission may be e.g. for a read access or for a read/write access. The permission may also contain information about the basis of the permission. One basis for a user to have access to a document may for example be that the same user has access rights to the document or has accessed the document in another system. Another basis for a user to have access to a document may be that another user, with whom the user has a trust relationship in a context, is allowed to access or has accessed the document in the context of the trust. A permission object 204 may thus be created between a user and a document when another user has accessed or has permission to access the document utilizing trust of the user. Yet another basis for user to have access permission to a document may be e.g. a rule that has been defined in the established trust relationship. For example, the rule may specify that the user, to whom the trust has been granted, has access permission to the same documents to which the grantor of the trust has access permission. Yet another basis for a user to have access to a document may be that the user has been associated with a destination (contact point) data object to which the platform (100 in FIG. 1) has assigned the document using e.g. some suitable document routing logic. The routing logic may be at least partially based on data sharing agreements of an embodiment of the present invention.

The data objects mentioned herein may be implemented in the memory of a computer e.g. as data objects or in any other manner accessible and modifiable by a processor of the computer. The functional components of various embodiments described herein, including steps of various methods, may be implemented as instructions executable in the memory of a computer by the processor of the computer.

In a preferred embodiment, the data model of FIG. 2a is used for user 203 access authorization purposes in a multitenant system comprising a plurality of organizations 201 and a plurality of documents 205, each document having at least one, preferably multiple, organizations as stakeholders. If a user 203 wants to represent an organization in a process involving a document, the user 203 needs to have established a trust link (relationship) 202 with the organization 201 either directly or via another user 203 who already has established a trust relationship 202 with the organization. Additionally, the user needs to have a permission link 204 to the document 205 and the organization 201 must be a stakeholder 206 of the document 205.

FIG. 2b depicts an exemplary arrangement for importing document data into document collection 205 of the storage 102 of platform 100 e.g. via a data exchange interface 211. The arrangement comprises a source of documents 210, for example a document router or an application service adapted to receive a document e.g. from the sender of the document for storing it in the data management system of the platform 100. Copies of the documents are transmitted from the source of documents to the collection of documents 205 using the data exchange interface 211 (101 in FIG. 1). The document source may also transmit supplementary data associable with the business documents. Such data may comprise e.g. access control information, event information or state change information related to the business document.

The documents imported to the document collection 205 are analyzed using for example an arrangement shown in FIG. 2c. The analysis is needed to establish the stakeholder relationships 206 between organizations 201 and the imported documents 205. The analysis is performed using a document analyzer component 220 which may be implemented e.g. as part of the application logic 103. The analyzer inspects the data (e.g. content and meta-data) of the imported document and determines based on its findings, which organizations are stakeholders of the document. The inspected data may comprise the content of the document. The content of the document may comprise e.g. the name and address information of the sender (seller) and recipient (buyer) of an invoice. In an embodiment, a specific combination of information may identify two stakeholders. E.g. the seller name specifies the seller but the associated address or other contact information specifies the financing service company who performs the invoicing on behalf of the seller. In such case, both the seller and the financing company should be added as stakeholders of the document. The content may also comprise meta-data related to the document. The meta-data of the document may comprise e.g. routing information of the document in a document routing network or some data related to an activity performed on the document. In addition to establishing the stakeholder relationships 206 between organizations 201 and documents 205, the document analysis process performed e.g. by the document analyzer component 220 determines the possible contexts 207 of the document 205. The context may e.g. indicate, which (kind of) services may be provided for the document. The process of determining the possible context may utilize e.g. the content of the document 205 or any properties or capabilities of the stakeholder organizations 201 as input. For example, a context may require a certain property from the document, a certain capability from the application services of the sender and/or a certain capability from application services of the receiver.

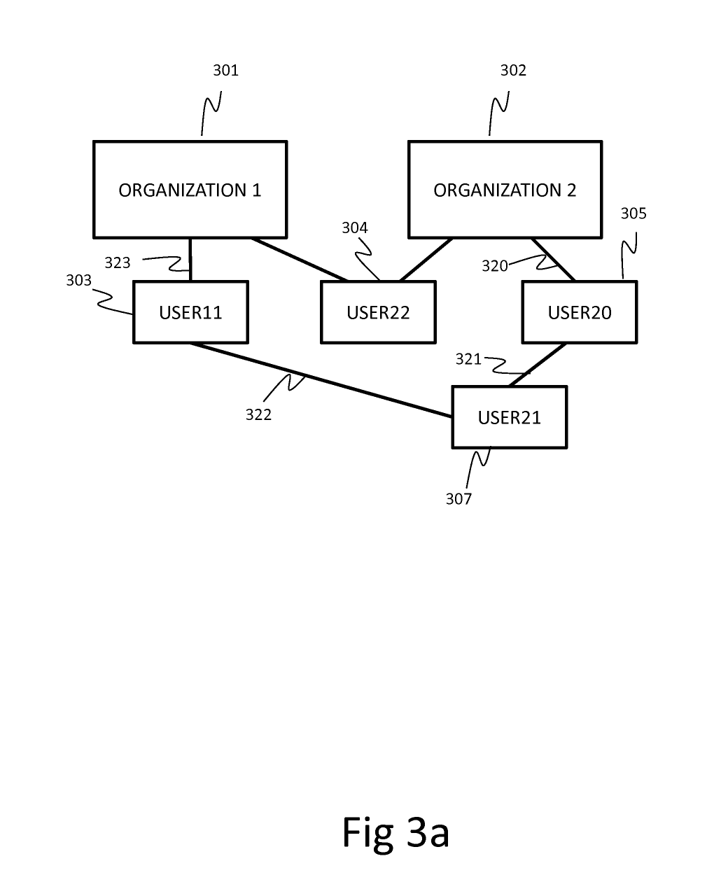

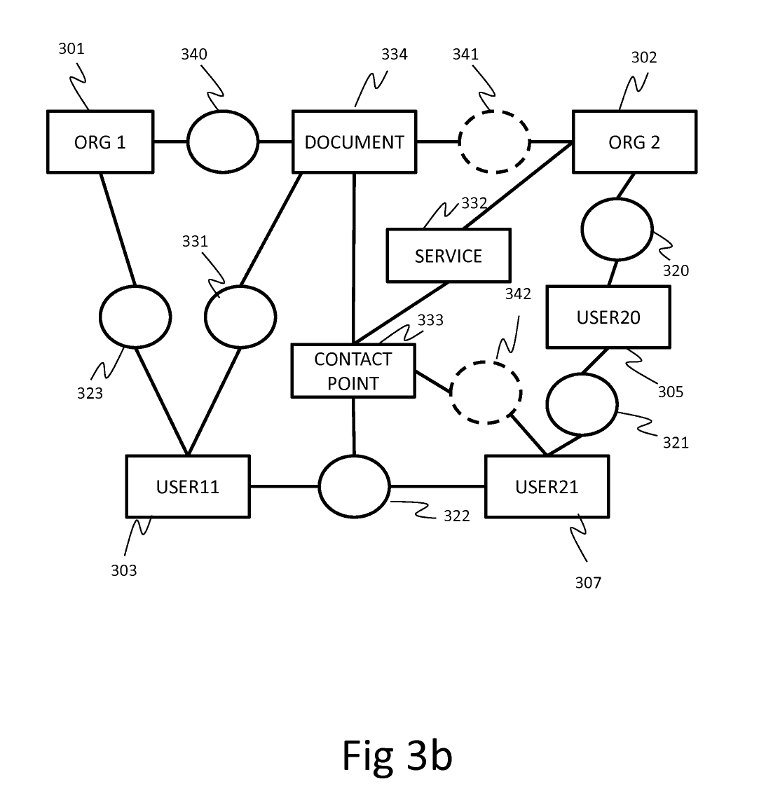

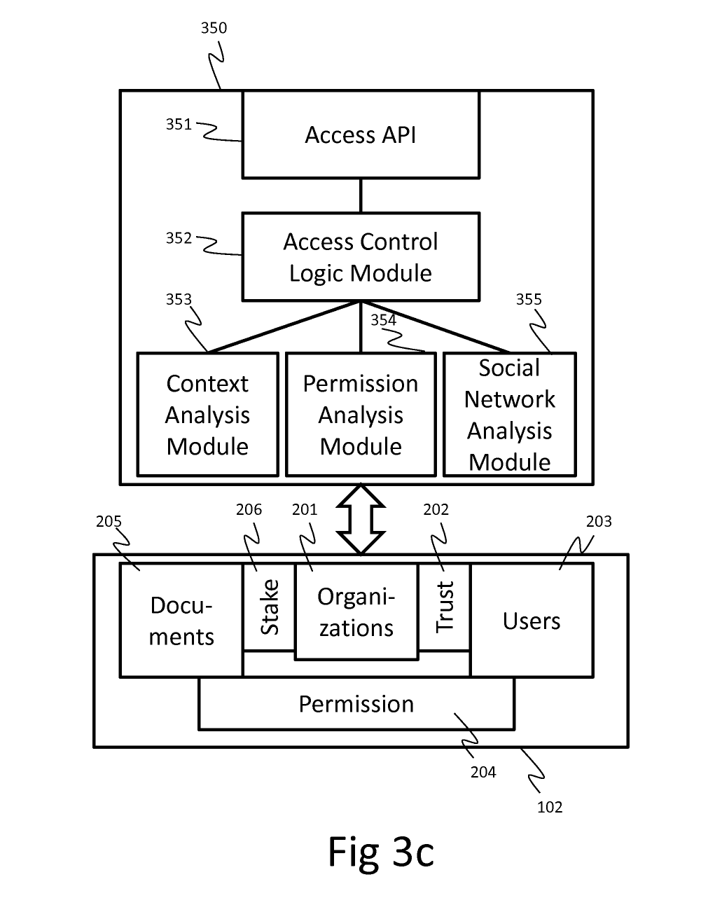

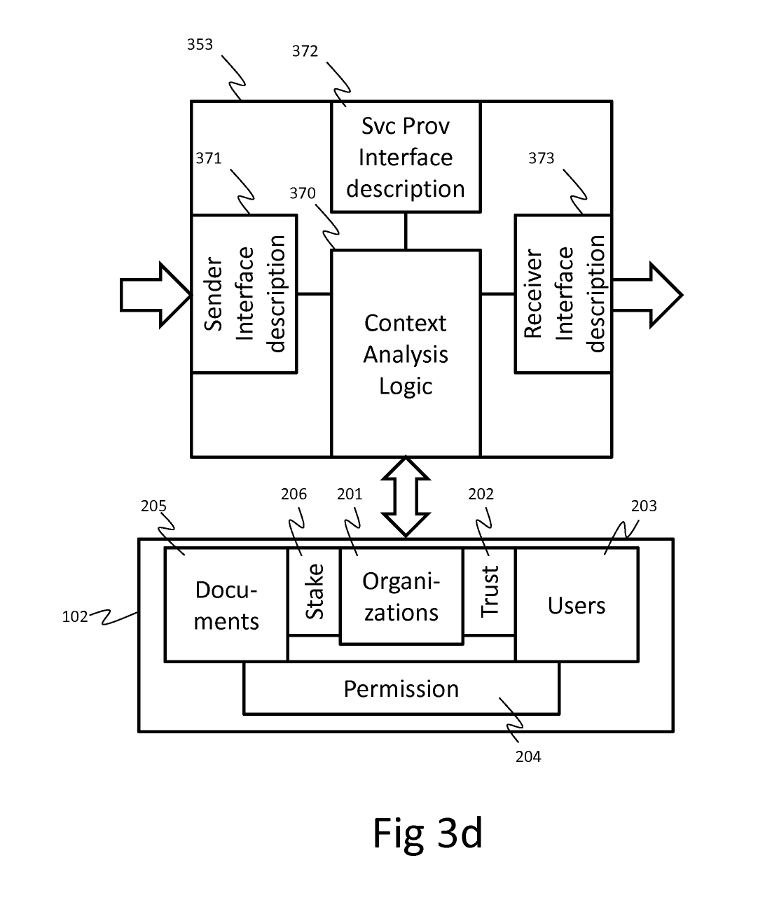

FIG. 3a shows an exemplary diagram of trust relationships on one hand between organizations and users and on the other hand trust relationships between users representing same or different organizations. In the figure, each line (e.g. 320) represents a trust relationship between an organization (e.g. 302) and a user (e.g. 305) or between users 321. A trust relationship allows the grantee user to represent the grantor in a context specified in the trust relationship. For example, the trust relationship 320 may authorize “USER20” 305 to represent the “ORGANIZATION 2” in a certain context, e.g in any activity regarding invoices of the organization. The USER20 305 may delegate at least part of this trust relationship further to another user, e.g. “USER21” 307 by establishing a new trust relationship 321. Now “USER21” is able to represent “ORGANIZATION 2” in the same context as “USER20” 305.

A user who has a trust relationship 323 with a first organization 301 may establish a trust relationship 322 with the user 307 who has a trust relationship (in the shown embodiment indirectly through trust links 321, 321) with the second organization 302. The established trust relationship 322 contains information about the context in which the user 303 and eventually the organization 301 trusts the user 307. The trust relationship 322 also contains information about organizations (301, 302) that the users represent while establishing the relationship. In a preferred embodiment, the trust relationship 322, that has been established between representatives 303, 307 of two different organizations 301, 302, represents an agreement to share at least some data of at least some documents of organization 301 with organization 302. The data sharing agreement information may be used e.g. when determining secondary stakeholders to a document. For example, the “ORGANIZATION 2” 302 may be assigned as a secondary stakeholder (e.g. as a service provider) to a document which already has “ORGANIZATION 1” 301 as a primary stakeholder (e.g. as a sender of the document), if the “USER11” 303 has established a trust relationship 322 with “USER21” 307 and the document in question belongs to a context specified in the trust relationship 322.

It is also noteworthy, that a single user, such as “USER22” 304, may be trusted directly by multiple organizations 301, 302. For example, the “USER22” 304 may be trusted in invoice management context by both the organizations 301, 302. For this reason, both organizations have granted the user rights to represent the respective organizations in the context of invoice management services.

FIG. 3b depicts some data and functional elements usable by a method of controlling access to a document according to a preferred embodiment of the present invention. In the shown example, user “USER11” 303 represents the organization “ORG 1” 301 via a trust relationship 323 in a context. For example, the trust relationship may allow the user to represent an organization in invoice-related contexts. Organization 301 is a primary stakeholder of the document 334 as represented by the stake object 340 which may have been created e.g. using method described in FIG. 2c. The user 303 has access rights to the document 334 as represented by the permission object 331 which may have been created e.g. using method shown in FIG. 2d. In an embodiment, the permission object may also be created using a rule associated e.g. with the trust relationship 323. In such rule, organization 301 may instruct the platform 100 to create for the user 303 permission objects 331 to all documents 334 that meet some specified data selection criteria. For example, the superuser of an organization, e.g. a user who is directly trusted by the organization in all contexts relevant to the organization, may have access to all documents of the organization in the platform.

In the example shown, there is also another organization “ORG 2” 302 who is represented in the platform 100 by “USER20” 305 via a trust relationship object 320 that allows user 305 to represent the organization 302 in a context. Advantageously, the context is related to at least one service provided by the organization 302. In a preferred embodiment, the organization 302 is an application service provider who provides services related to the document 334, e.g. an invoice, to a plurality of organizations, of which one is the organization 301. The user 305 has delegated some of the trust he/she has received from the organization 302 further to user “USER21” 307 by means of a trust object 321.

To continue the example further, the user 303 representing the organization 301 in a context, e.g. invoicing, wants to establish a service subscription on behalf of the organization 301, to an application service 332 that belongs to the desired context. The service is provided by the organization 302. In order for the organization 302 to access the document data 334 required by the service 332, a trust relationship 322 must be established between the user 303 and user 307 for the desired service context, e.g.

invoice automation services. While the trust relationship 322 is valid, the organization 302 may be regarded as a secondary stakeholder 341 of documents 334 where the organization 301 is a primary stakeholder, e.g. a sender or receiver of an invoice. In other words, the organization 302 may be a secondary stakeholder of a document 334 in a context as long there exists a valid trust relationship 322 for the context between the users 303 and 307 wherein the user 303 represents a primary stakeholder. The trust (agreement) relationship 322 may comprise or be associated with data selection rules which define, for which (subset of the) transactions of the primary stakeholder 301 the organization 302 may be considered as a secondary stakeholder. Further, the user 307 may use the conditional access permission 342 to access the document 334 via the contact point 333. The conditional access permission 342 may be specified to be valid, e.g. when the trust relationship (data sharing agreement 322) is valid. In an embodiment, the data sharing agreement may be valid, when the trust relationships 323, 321 and 320 are valid in the context of the data sharing agreement 322, i.e. there is a valid chain of trust between organizations 301 and 302. Now that the access permission 342 exists for the user 307 and stake 341 exists for the organization 302, the service 332 may access the document via the contact point 333. In the shown embodiment, the contact point 333 is an addressable destination for the organization 302 within the platform (100 in FIG. 1) specified in the data sharing agreement 322. The contact point's availability to the service 332 is conditional to the validity of the trust relationship of the data sharing agreement 322. Should the trust relationship 322 become invalid, e.g. via revocation by user 303 or 307 or via expiration, the access of service 332 to the document 334 is denied because the contact point 333 is not a valid one any more for the service.

In an embodiment, the conditional stake object 341 and/or the conditional permission object 342 may comprise, or have access to, instructions for adapting the content of the document 334 that is shown to the user 307 representing the organization 302. For example, some data content of the document may be hidden from the user 307 or delivered to the user in an obfuscated form when accessed in the context. The data adaptation instructions may be associated e.g. with the data sharing agreement 322 established between the organizations 301 and 302.

FIG. 3c depicts an exemplary, highly simplified diagram of an access control module 350 of an embodiment of the present invention. Like any other functional module of the present invention, the module may be implemented as a computer program code comprising processor executable instructions and utilizing persistent and/or volatile computer memory. The module comprises an Access API (Application Programming Interface) 351 that publishes services needed e.g. for requesting access to a document. A typical access request comprises information about the user requesting the access and about the context for which the access is requested. The interface utilizes for implementation of the services the functionality of the Access Control Logic Module 352. In a preferred embodiment, the access control logic module further utilizes functionality provided by the Context Analysis Module 353, Permission Analysis Module 354 and Social Network Analysis Module 354. All modules utilize the data 201-206 of the storage 102.

The Context Analysis Module 353 analyzes the content and/or properties of the documents 205 and their relationships with e.g. organizations for the purpose of identifying, whether a certain context (e.g. a group/category of services) is possible for the document 205. For example, the module 353 may analyze, if the context of electronic invoice routing services is possible for an invoice that has been received into the database of storage 111. For such context, the received document must be translated (or must be translateable) into a format of an electronic invoice and the recipient organization (stakeholder) of the document must be able to receive and process such invoices.

The Permission Analysis Module 354 comprises functionality for determining, if a user 203 is allowed to access a document 205 in general. In a preferred embodiment, the user 203 must have both a general permission 204 to access a document and also a permission to represent the organization in the context (granted in a trust relationship 202) where the document 205 is to be used.

The Social Network Analysis Module 355 analyses trust relationships 202 between users 203 and between users and organizations 201. The module 355 is thus able to determine e.g. if a user 203 is permitted to represent an organization 201 in a specified context.

FIG. 3d depicts in more detail the Context Analysis Module 353. The module comprises Context Analysis Logic 370 that is in a preferred embodiment implemented using computer executable instructions. The logic 370 has access to the data of the database of storage 102 of which it uses especially the document 205, organization 201 and stake 206 data. Additionally, the logic has access to a plurality of interface descriptions, which describe the capabilities of stakeholders of documents. In the embodiment shown, there is a description of sender interface 371, service provider interface 372 and receiver interface 373.

To further elaborate the process of analyzing existence of a context for a document, an example about invoice factoring context is provided herein. To determine, if a document 205 may be used in the context of invoice factoring service, a number of conditions may need to be met. First, the document 205 must be an invoice that has a discount percentage for immediate payment. Second, there must be a secondary stakeholder relationship 206 (341 in FIG. 3b) between an organization 201 providing the factoring service and the invoice document 205. The data, e.g. the discount percentage, required by the factoring service is described e.g. in the service provider interface description 372. Third, the receiver organization 201 (stakeholder) of the invoice must be able to receive factored invoices. This ability is described in the receiver interface description 373. In a further example, the receiver is able to receive better service (e.g. in form of a discount) from the factoring service provider, if the receiver of the invoice is able to send document status update information to the document collection of the database of storage 111. For example, a quick approval and/or payment of an invoice may be rewarded by the factoring service provider in the form of a discount.

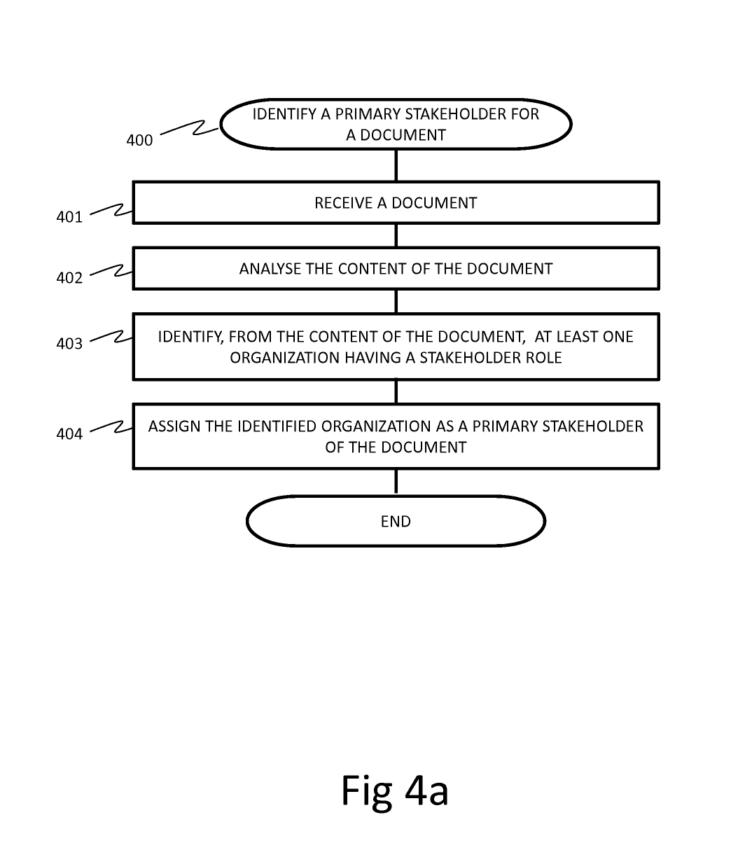

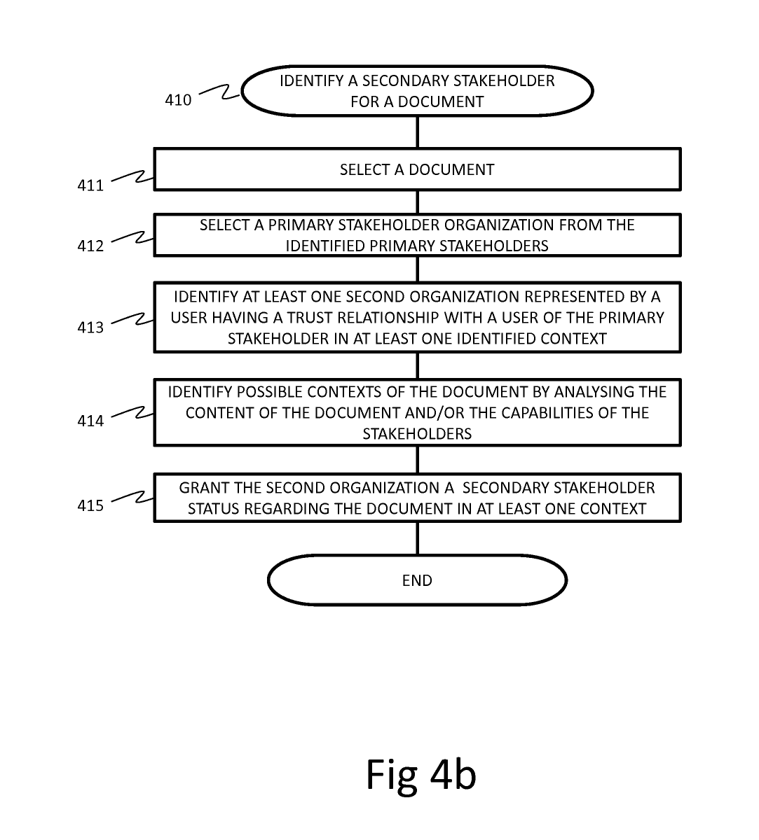

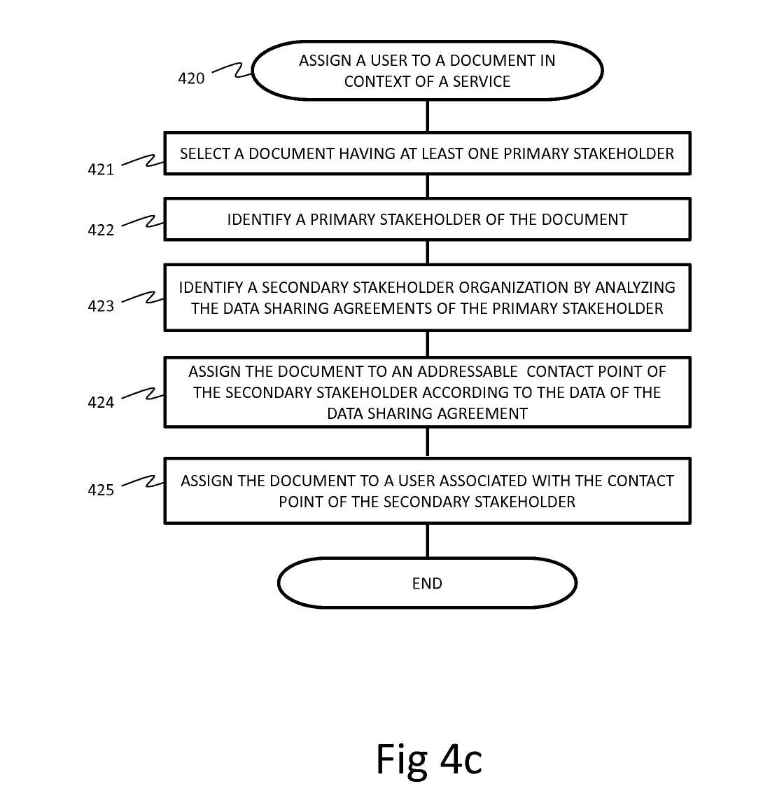

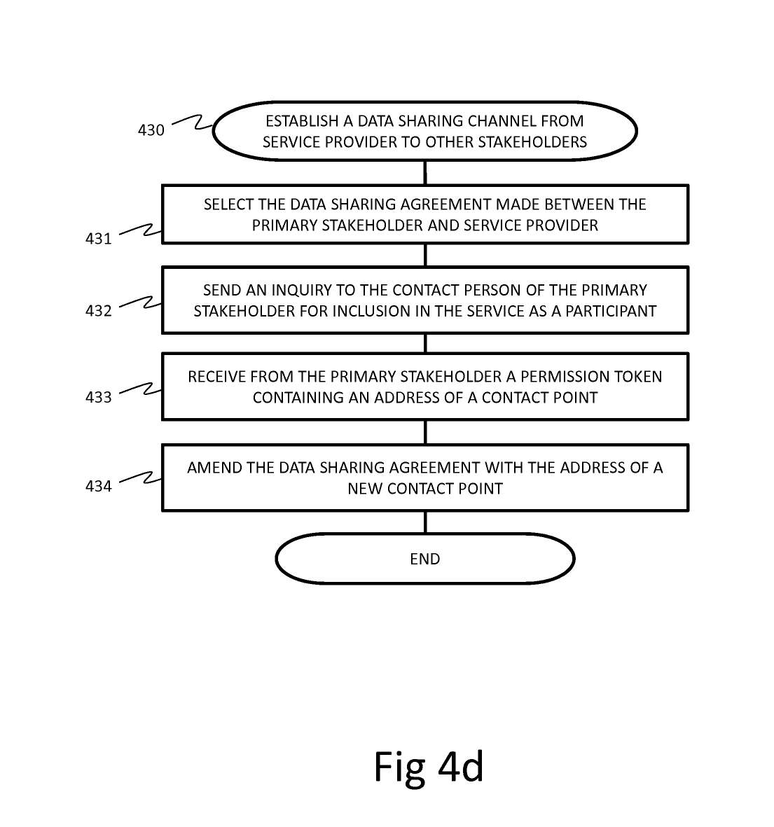

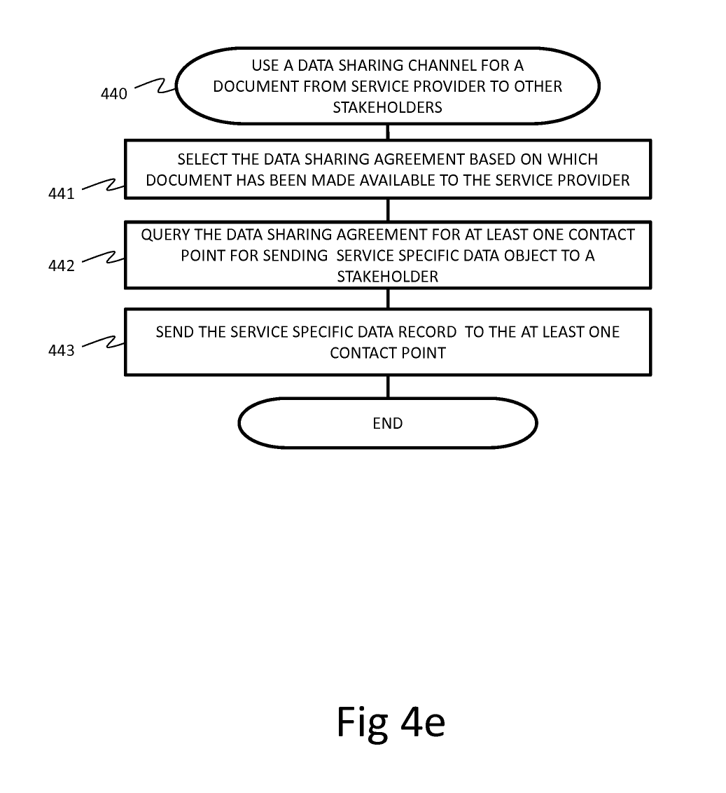

FIG. 4a shows a flow diagram about identifying 400 a primary stakeholder of a document. In step 401, a document is received into the database residing in the storage 102 of the platform 100. The document may have any suitable format comprising structured and/or unstructured data. The structured data may be e.g. XML data and the unstructured data may be e.g. document image data. In step 402, the content of the document is analyzed. If the content is in an unstructured format, the content is converted into a structured format so that individual data fields (items) of the document may be assigned a semantic meaning. Next, in step 403, at least one organization (201 in FIG. 2a) is identified from the content of the document to have a pre-determined primary stakeholder role in the document. Such pre-determined role may be e.g. a sender or a receiver of an invoice. In an embodiment, the primary stakeholder identification process must identify at least two primary stakeholders for the document. Failure to do so marks the document as an erroneous document that requires e.g. manual resolution. The identified organizations must be available in the organization data collection of the database of the data storage 102. Finally, in step 404, the identified organizations are assigned as primary stakeholders of the document. The primary stakeholders may be considered as the (joint) owners of the data of the document.

In a preferred embodiment, the document may also have at least one secondary stakeholder. In an embodiment, an organization is a secondary stakeholder to a document, if a trust relationship allowing data sharing in the context of a service between the organizations exists between a user representing the primary stakeholder of the document and a user representing the second organization. Such trust relationship is referred herein as a data sharing agreement. The flow chart of FIG. 4b depicts an exemplary method 410 of identifying such stakeholders utilizing an embodiment of the present invention. In step 411, a document is selected for the process. The document may be e.g. a document that was received in the process described in FIG. 4a. Next, in step 412, a previously identified primary stakeholder is selected from the list of primary stakeholders of the document. In step 413, at least one second organization is identified, whose representative user, i.e. user who is allowed to represent the organization, has a trust relationship with the representative user of the primary stakeholder in at least one context. The trust relationship forms a data sharing agreement where the first and the second organizations are parties of the agreement. If the data sharing agreement comprises or is associated with data selection rules (criteria), the method checks that the document meets those rules. Additionally, the method may check, if a primary stakeholder, which may not be the same as the primary stakeholder of the data sharing agreement, of the document has a capability required by the service provided by the second organization. For example, a receiver of an invoice may need to be able to receive electronic invoices transmitted by a service provider who has a data sharing agreement with the sender of the invoice. Those documents that fail to meet the rules are ignored and are not made available to the secondary stakeholder. Next, in step 414, possible contexts (and consequently possible services that may be available to the document) of the document are identified. In a preferred embodiment, the identification process inspects the content of the document and/or the capabilities of the already known possible stakeholders of the document. For example, a document may belong to an electronic invoice routing context, if the document can be interpreted as an electronic invoice, i.e. it is already one or it can be translated into one, and the receiver of the document, i.e. a primary stakeholder, is capable of receiving electronic invoices. Finally, in step 415, the second organization is granted a secondary stakeholder status to the document in the context specified in the data sharing agreement. For example, an organization providing electronic invoice routing services may be granted a secondary stakeholder status to the document in the context of routing of electronic invoices. In a preferred embodiment, the secondary stakeholder status is valid as long as the data sharing agreement is a valid one and the users of the agreement are trusted by their respective organizations e.g. in the context(s) specified in the agreement.

FIG. 4c depicts a method 420 of assigning a user representing a secondary stakeholder to a document in the context of a service according to a preferred embodiment of the present invention. In step 421, a document is selected. In a preferred embodiment, the document has a plurality of primary stakeholders, e.g. the sender and the receiver of an invoice. In step 422, the method identifies a primary stakeholder of the document using e.g. the method 400 described in FIG. 4a. In step 423, the method identifies a secondary stakeholder e.g. using method 410 of FIG. 4b.

Next, in step 424, the method assigns the document to an addressable contact point of the secondary stakeholder according to the data of the data sharing agreement. In an embodiment, the contact point is a destination address e.g. within the platform 100 for documents or references to documents from which a user or service of a stakeholder may access the documents and possibly also other data related to the documents. In an embodiment, the address may be expressed e.g. as an URL or as an electronic mail address or as any other suitable address identifying the contact point or at least one user having access to the contact point. The contact point is associated 425 with at least one user or service. This at least one user or service has access to the documents that are available at the addressable destination, e.g. a URL. The user may not necessarily be the same as the user who has established the data sharing agreement with the primary stakeholder. The data sharing agreement between a primary stakeholder and a service provider (secondary stakeholder) may be established e.g. by a sales person of the service provider. However, the sales person may not need to see the data of the primary stakeholder and thus may not be allowed to see it. Preferably, the contact point has means to restrict access of unauthorized users to the data of the contact point.

The service provided by the service provider typically produces some data whose structure and content is specific to the service. Such service-specific data may need to be communicated back to the primary stakeholder of the document and/or additional primary or secondary stakeholders of the document. An exemplary method of establishing such communication channel is provided in FIG. 4d. In step 431, the data sharing agreement is selected. The agreement identifies a contact person from the primary stakeholder. In an embodiment, the contact person is the person who has established the data sharing agreement with the secondary stakeholder, i.e. the service provider. Next, in step 432, the service provider sends, using a system service provided by the application logic 103 the platform 100, an inquiry to the contact person for inclusion in the service as a participant. The platform 100 may amend the inquiry object with some additional data, e.g. information about the context (e.g. invoice financing) of the service provided by the service provider. Next, in step 433, the contact person of the primary stakeholder sends, using a service provided by the platform 100, a permission token to the service provider. The token contains an address of a contact point of the primary stakeholder to be used in the data exchange between the service provider and the primary stakeholder. In step 434, the data sharing agreement is amended using the token data by a service provided by the platform 100.

FIG. 4e depicts an example method 440 about using a data sharing channel for a document to allow service provider communicate with the stakeholders of the document regarding the document. In step 441, a data sharing agreement is selected, based on which the document has been made available to the service provider. In an embodiment, the agreement is identified based on the address of the contact point in which the document is available to the secondary stakeholder. In step 442, the identified agreement is queried for information about at least one contact point that has been made available for the purpose of information exchange between the service provider and other stakeholders of the document. In step 443, the service sends a service-specific data record to the at least one contact point that is accessible by another stakeholder of the document.

In an embodiment (not shown in figures), the contact person of the primary stakeholder (e.g. the seller) may forward the inquiry data object to a contact person of a second primary stakeholder (e.g. the buyer) of the documents that meet the data selection rules of the data sharing agreement. The forwarding may be automated by a system service provided by the platform 100. The automation may for example forward the inquiry automatically to a new second primary stakeholder whenever such is identified, e.g. when a new document having a previously unknown second primary stakeholder is shared with the service provider according to the data sharing agreement. The contact person of the second primary stakeholder may be selected automatically by the platform 100 according to some suitable user selection logic. The contact person of the second primary stakeholder may further forward the inquiry to at least one secondary stakeholder who has a data sharing agreement with the second primary stakeholder. The inquiry forwarding mechanism allows inclusion of multiple organizations and users from those organizations into a service in a convenient and reliable manner.

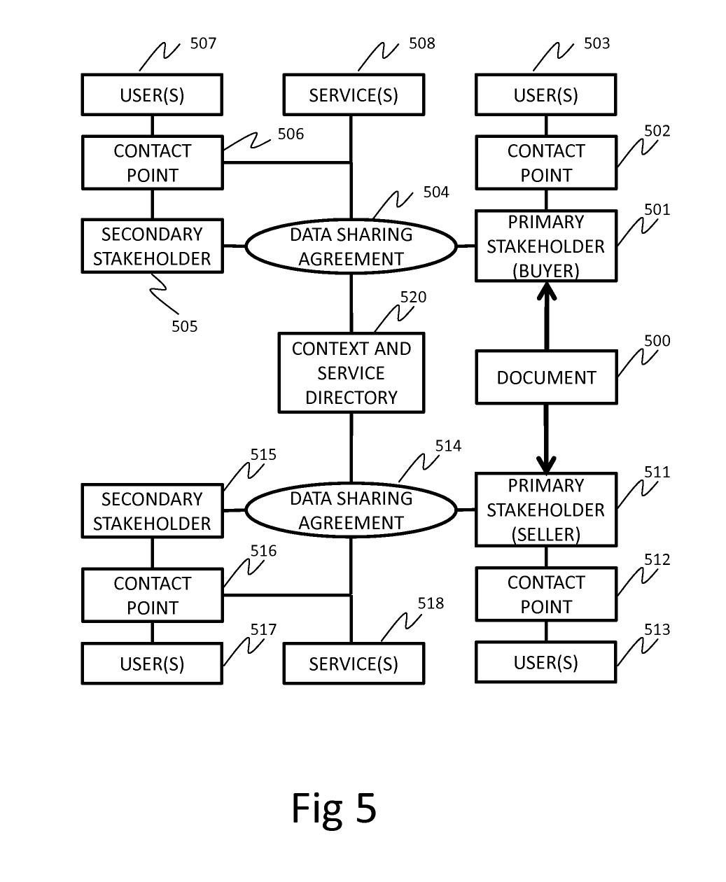

An example about a scenario where there are multiple parties that need to be able to participate in communication related to a document and to a service is provided next in FIG. 5. When the data of a document 500 is written in the data storage 102 of platform 100, the stakeholders and users representing those stakeholders, who are allowed to access the document, need to be determined. First, the document content and/or meta data of the document are analyzed to identify primary stakeholders 501, 511 of the document. In a preferred embodiment, the primary stakeholders are the buyer and the seller of a business transaction document, e.g. an invoice or a purchaser order. The identification may be performed e.g. using the method described in FIG. 4a. Next, at least one contact point 502, 512 of each primary stakeholder is determined with which the document needs to be assigned. The assignment may be performed e.g. based on the data content and/or other properties of the document. For example, for buyer 501, there may be a contact point 502 for all incoming invoices. Similarly, for seller 511, there may be a contact point 511 for all outgoing invoices. For each contact point, at least one user 503, 513 is assigned. The assigned users have access to all the documents and data related to the documents that are assigned with the contact point. In a preferred embodiment, a user who has been assigned to a contact point may delegate his access rights to another user.

Once the primary stakeholders of the document have been identified, the routing logic 104 of the platform 100, possibly together with application logic 103 analyses the currently existing and valid data sharing agreements 504, 514 of the primary stakeholders to identify organizations (legal entities) 505, 515 who are secondary stakeholders of the document 500 and who should thus have access to the document. In a preferred embodiment, at least some of such secondary stakeholders provide services 508, 518 related to the document 500. The data sharing agreements 504, 514 specify the contact points 506, 516, from which the services 508, 518 may access the document 500. Each of the contact points 506, 516 may also be associated with at least one user 507, 517 who represent the secondary stakeholder. In a preferred embodiment, the associated users will have access to the document(s) 500 of the contact point and the data related to the contact point.

A service 508 related to a document typically produces service-specific data that needs to be communicated to at least one stakeholder of the document. In an embodiment, the stakeholder is the primary stakeholder 501 of the document. The service-specific data needs to be communicated to at least one contact point 502 from which at least one user 503 is able to access the data. In a preferred embodiment, the information about the contact point 502 (e.g. the address, e.g. URL, of the contact point) to be used for the service-specific communication is defined in the data sharing agreement 504. The definition may be included in the agreement when the agreement has been established or the agreement may be amended later. The data sharing agreements thus may act as location of information about communication arrangements between organizations and users related to a context and/or a service. This information may be valuable when analyzing how a business network between organizations and users actually works.

The provider 505 of the service 508 may also need to communicate with other stakeholders. However, the service 508 may not be able to automatically contact any other party but the primary stakeholder 501. For example, provider of a collaboration service, e.g. an invoice dispute resolution service, may need to establish communication not only with the buyer 501 but also with the seller 511 and a provider 515 of service 518 subscribed by the seller, e.g. supplier financing service. To do this, the secondary stakeholder 505 may send an invitation to the buyer 501 who may forward it to the seller 511. The invitation may comprise information about the service from the context and service directory 520 which is a directory (service catalog and classification service) maintained by system services of the application logic 103 of the platform 100. The seller 511 may accept the invitation by returning the invitation to the service provider 505 with contact point information 512. The seller 511 may also forward the invitation to the supplier financing service provider 515 who may accept it in a similar manner, i.e. by returning the invitation to the secondary stakeholder 505 with contact point information 516. The contact point information of the data sharing agreement 504 may now be amended with the new contact points. Now some potentially valuable information has been established in the data sharing agreement 504 about actual communication arrangements related to a document and a service.

The invitation to be forwarded from primary stakeholder 501 to a second primary stakeholder 511 may be a re-usable one. For example, it may be automatically sent to a different second primary stakeholder 511, whenever the service 508 is activated in conjunction with a new document 500 that has a new second primary stakeholder 511, e.g. a new seller.

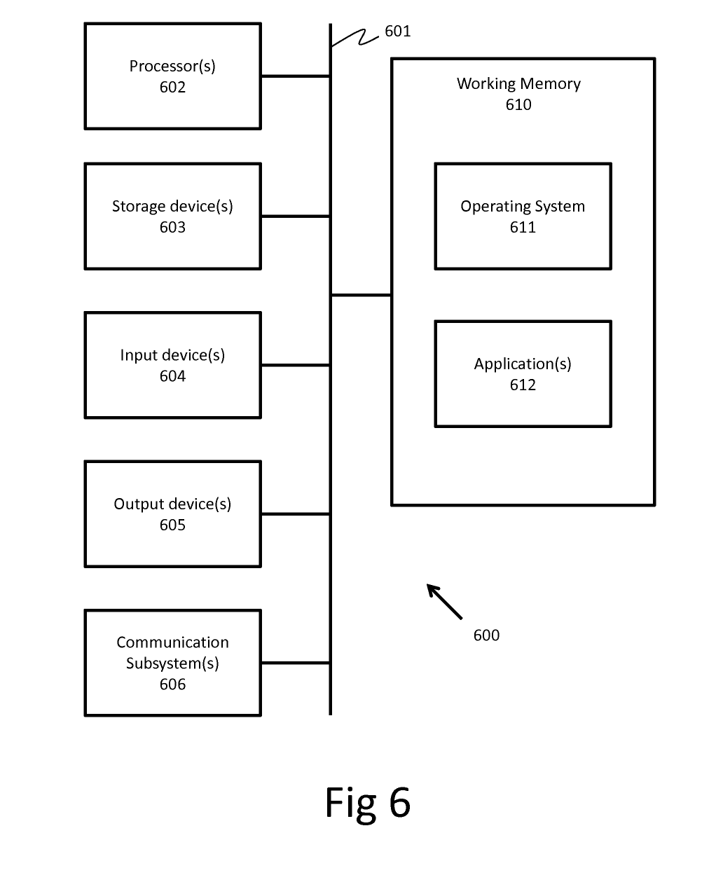

FIG. 6 shows a schematic illustration of one embodiment of a computer system that can perform the methods of the described embodiment. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 601 (or may otherwise be in communication, as appropriate). The hardware elements can include one or more processors 602, communication subsystems 606, one or more input devices 604, which can include without limitation a mouse, a keyboard and/or the like; and one or more output devices 605, which can include without limitation a display device, a printer and/or the like. The computer system 600 may further include (and/or be in communication with) one or more storage devices 603. The computer system 600 also can comprise software elements, shown as being located within the working memory 610, including an operating system 611 and/or other code, such as one or more application programs 612, which may comprise computer programs of the described embodiments, and/or may be designed to implement methods of the described embodiments of a computer-method of the embodiments as described herein.

At least some embodiments include a program storage device readable by a machine, tangibly embodying a program of instructions executable by the machine to perform a computer-executable method of an embodiment of the present invention.

Although specific embodiments have been described and illustrated, the embodiments are not to be limited to the specific forms or arrangements of parts so described and illustrated.

1. A computer-implemented method of an application service execution platform for a first user authorized to represent a first organization in the context of at least one service and a second user authorized to represent a second organization in the context of the at least one service to enter an agreement to share at least one data object owned by the first organization, wherein the method comprises steps:
a. establishing, between the first and the second organizations represented by the first user and the second user, a data sharing agreement for the context of the at least one service,
b. specifying in the data sharing agreement at least one data selection rule to specify data objects that are made available to the second organization for providing the service of the specified context wherein the data selection rule is at least in part defined by the context of the at least one service, and
c. specifying in the data sharing agreement for the data objects meeting the at least one data selection rule at least one addressable destination in which the data object is available for at least one user representing the second organization or for at least one service provided by the second organization.

2. A method according to claim 1, wherein the context data and the data selection rules associable with the context data are arranged to be shareable by a plurality of services and specified and maintained by services of the platform.

3. A method according to claim 2, wherein the association of a service with a context is adapted to be established, maintained and/or revoked using services of the platform.

4. A method according to claim 1, wherein the availability of the data of the addressable destination to the user representing the second organization is subject to the validity of the data sharing agreement.

5. A method according to claim 4, wherein the validity of the data sharing agreement is subject to the validity of the trust relationships of the first and the second users with their respective organizations and of the trust relationship between the first and the second users in the context of the data sharing agreement.

6. A method according to claim 1, wherein the method further comprises, for the purpose of sharing service-specific information produced by the service provided by the second organization, the step of determining for the information produced by the service at least one addressable destination specified by the first organization in which destination the information is available to at least one user representing the first organization.

7. A method according to claim 6, wherein the method further comprises, for the purpose of sharing, with a user representing a third organization, service-specific information produced by a service provided by the second organization, the steps:
a. creating a request to share service-specific information associable with at least one document meeting the criteria of the data sharing agreement established between the first and the second organizations,
b. sending the request to a user representing the first organization,
c. the user authorizing, using a service of the platform, forwarding of the request to a user representing a third organization that is also a stakeholder of the at least one document, and
d. receiving approval from the at least one third organization wherein the data of the approval comprises address of at least one addressable destination to be used in the service-specific communication between the second and the third organization.

8. A method according to claim 7, wherein the method further comprises the step of updating the data sharing agreement with information about the received addressable destination to be used in the service-specific communication.

9. A computer system having means for a first user authorized to represent a first organization in the context of at least one service and a second user authorized to represent a second organization in the context of the at least one service to enter an agreement to share at least one data object owned by the first organization, wherein the means comprise:
a. establishing, between the first and the second organizations represented by the first user and the second user, a data sharing agreement for the context of the at least one service,
b. specifying in the data sharing agreement at least one data selection rule to specify data objects that are made available to the second organization for providing the service of the specified context wherein the data selection rule is at least in part defined by the context of the at least one service, and
c. specifying in the data sharing agreement for the data objects meeting the at least one data selection rule at least one addressable destination in which the data object is available for at least one user representing the second organization or for at least one service provided by the second organization.

10. A computer executable program product of an application service execution platform for a first user authorized to represent a first organization in the context of at least one service and a second user authorized to represent a second organization in the context of the at least one service to enter an agreement to share at least one data object owned by the first organization, wherein the program product comprises computer executable instructions for:
a. establishing, between the first and the second organizations represented by the first user and the second user, a data sharing agreement for the context of the at least one service,
b. specifying in the data sharing agreement at least one data selection rule to specify data objects that are made available to the second organization for providing the service of the specified context wherein the data selection rule is at least in part defined by the context of the at least one service, and
c. specifying in the data sharing agreement for the data objects meeting the at least one data selection rule at least one addressable destination in which the data object is available for at least one user representing the second organization or for at least one service provided by the second organization.
